(19) United States
(12) Patent Application Publication
(10) Pub. No.: US 2002/0180221 A1
(43) Pub. Date: Dec. 5, 2002

(54) Stop bar for door security

(76) Inventor: Patrick Watkins Flowers, Spring Lake, NC (US)

Correspondence Address: Patrick Watkins Flowers, 1133 Shady Grove Road, Spring Lake, NC, 28390, US

(21) Appl. No.: 09/836,671

(22) Filed: Apr. 16, 2001

(51) Int. Cl. E05C 17/54

(52) U.S. Cl. 292/339

(57) ABSTRACT

A brace bar (10) of square cross-section aluminum tube one inch outside diameter, forty inches in length to which a knob fork (11) is affixed at one end and a floor foot (12) affixed at the opposite end by means of roll pins (14) that act as axles allowing both to pivot. A bar handle (13) is affixed just below the midpoint on the front surface of the brace bar (10). Both the knob fork (11) and the floor foot (12) are dipped in a rubberized coating (16).

### CROSS-REFERENCE TO RELATED APPLICATIONS

Not applicable

### BACKGROUND

1. Field of Invention

This invention relates to the field of security devices that prevent a hinged door from being opened from the outside, specifically a device that may be manually placed under a door knob and braced against the floor to prevent the door from being opened.

2. Description of Prior Art

Hinged doors often provide little security from outside intruders for a number of reasons. The locking system hardware may not be of either sufficient size or strength to prevent easy intruder entry. Lock security may be compromised due to multiple keying. Further, there may be no locking device present in the door or jamb. As a result of these factors, supplemental security for hinged doors has been identified as an important means of providing security for individuals and personal property.

A number of approaches to supplemental door security have been employed. Those that rely on either the integrity of the jamb or door frame may be rendered ineffective by either the materials or construction techniques used in the jamb or frame assembly. Another class of devices has been created that brace the door from the inside. These employ a system that braces the door by means of an angled bar that has one end designed to fit under the doorknob and the other end designed to allow friction or pressure to hold a foot device against the floor. Any attempt to open the door from the outside results in the bar being firmly wedged in place, thus preventing intruder entry.

Two types of angled bar security devices are the “Big Jammer” door brace manufactured by Mace Security International and “Door Security Bar” manufactured by Master Lock. Both of these devices suffer from drawbacks. The “Big Jammer” is made of steel and heavy to both transport and handle, and it is a multi-function device that requires individual configuration depending service application. The Master Lock “Door Security Bar” subjects the doorknob to bending stresses it was not designed to withstand since it employs a mechanical pressure device to lock the bar under the knob. This may ultimately result in knob assembly failure thus actually reducing security. Both the Mace “Big Jammer” and the Master Lock “Door Security Bar” as well as all other angled bar security devices heretofore known suffer from the additional disadvantages in that:

(a) They are not easy to operate, because they either require some assembly or special configuration, or require a degree of physical strength or manual dexterity to operate.

(b) They require following detailed operation instructions for setup and proper function.

(c) They have no handle to assist in placement or easy removal.

### SUMMARY

In accordance with the present invention a security stop bar comprises a forty inch bar with a pivoting fork on one end, a pivoting foot on the other and a handle just below the midpoint of the bar.

Objects and Advantages

Accordingly, besides the objects and advantages of the security stop bar described in the above patent, several objects and advantages of the present invention are:

(a) to provide a security stop bar which is easy to operate, without requiring assembly, physical strength, or manual dexterity;

(b) to provide a security stop bar that does not require complicated setup or operating instructions;

(c) to provide a security stop bar that has a handle for easy, placement, removal, and transport;

Further objects and advantages are to provide a security stop bar which is easy to use by the mobility, facility, or visually impaired individual, and the elderly. These are the population groups who may have the greatest need for personal security.

### DRAWING FIGURES

In the drawings, the figures have the same numeric references.

FIG. 1A shows the security stop bar in frontal view.

FIG 1B shows the security stop bar in side view.

FIG. 2A shows the security stop bar in exploded view.

FIG. 2B shows detail of the folding hinge.

FIG. 3 shows the security stop bar in situ bracing a door.

Reference Numerals in Drawing

| | | | |
|---|---|---|---|
| 10 | brace bar | 11 | knob fork |
| 12 | floor foot | 13 | bar handle |
| 14 | roll pin | 15 | handle screws |
| 16 | rubberized coating | 17 | center hinge |
| 18 | hinge slide lock | 19 | door knob |
| 20 | floor surface | 21 | door |

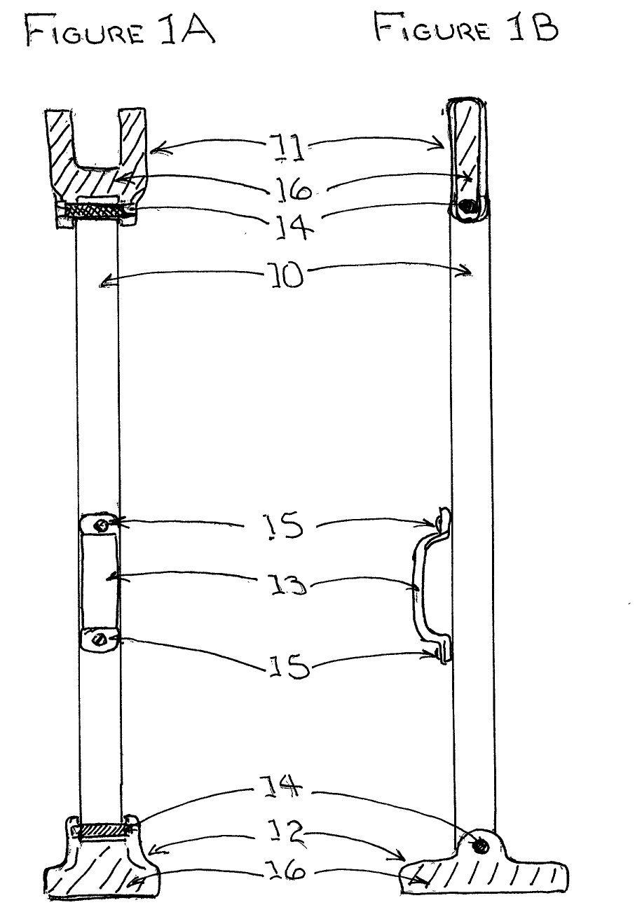

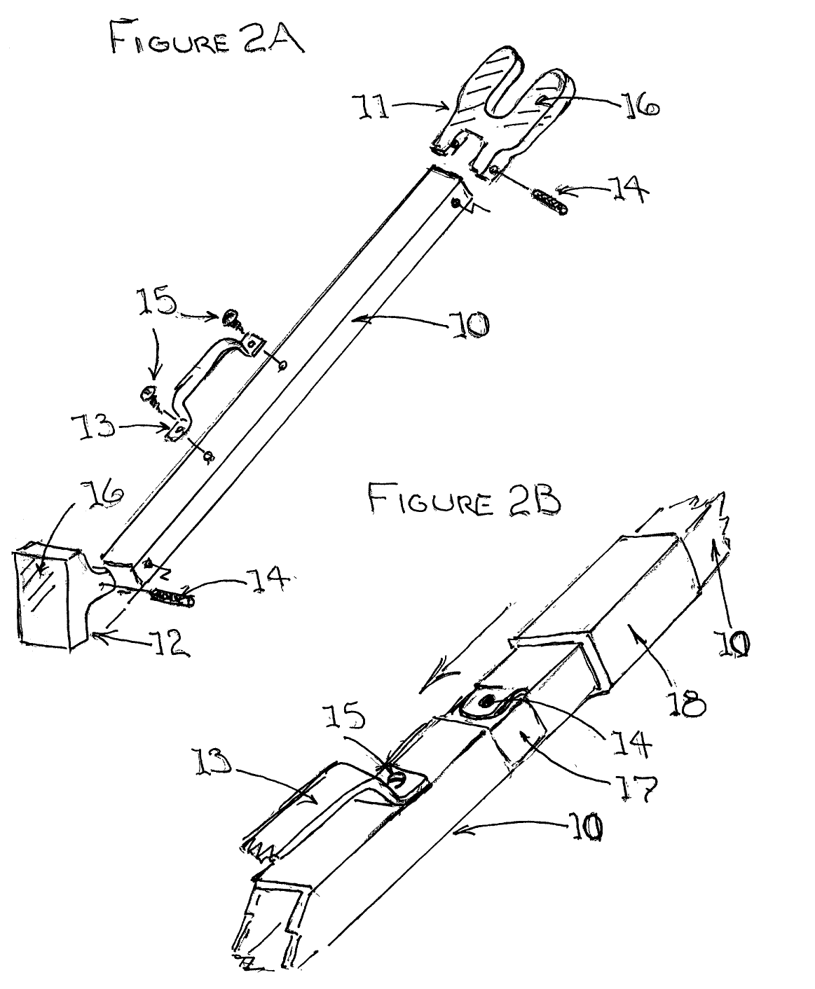

Description-FIGS. 1A, 1B, and 2A-Preferred Embodiment

A preferred embodiment of the security stop bar of the here presented invention is illustrated in FIG. 1A (front view), FIG. 1B (side view), and FIG. 2A (exploded view). The security stop bar has a brace bar (10) of square cross-section aluminum tube, one inch outside diameter, forty inches in length. To one end of the brace bar (10) a knob fork (11) is affixed by means of a roll pin (14). To the opposite end of the brace bar (10) a floor foot (12) is affixed in the same plane as the knob fork (11) by means of a roll pin (14). The roll pins (14) act as axles allowing both the knob fork (11) and the floor foot (12) at opposite ends of the brace bar (10) to freely pivot in the same axis. Just below the midpoint on the front surface of the brace bar (10) a bar handle (13) is affixed by means of handle screws (15). Both the knob fork (11) and the floor foot (12) are dipped in a rubberized coating (16) to prevent surface marring and increase friction and adhesion.

FIG. 2B—Alternative Embodiment

The detail of an alternative embodiment, a folding center hinge, is illustrated in FIG. 2B. Easy transportation of the security stop bar may be facilitated by means of adding a center hinge (17) to the center of the brace bar (10). A hinge slide lock (18) composed of one inch inside diameter aluminum tube is affixed by sliding it over the upper segment of the brace bar (11) allowing gravity to assist in the placement of the slide lock (18). The bar handle (13) acts as a lower stop for the hinge slide lock (18).

Advantages

From the descriptions above a number of advantages of the security stop bar of this invention become obvious.

(a) The stop bar is easy to operate since it does not require any assembly or special configuration, and further, no physical strength or manual dexterity is required for operation.

(b) No detailed operating or setup instructions or procedures are required.

(c) A handle is provided to facilitate easy placement, removal, and transportation of the security stop bar.

(d) The elderly, facility, mobility, or visually impaired individuals can easily operate the security stop bar.

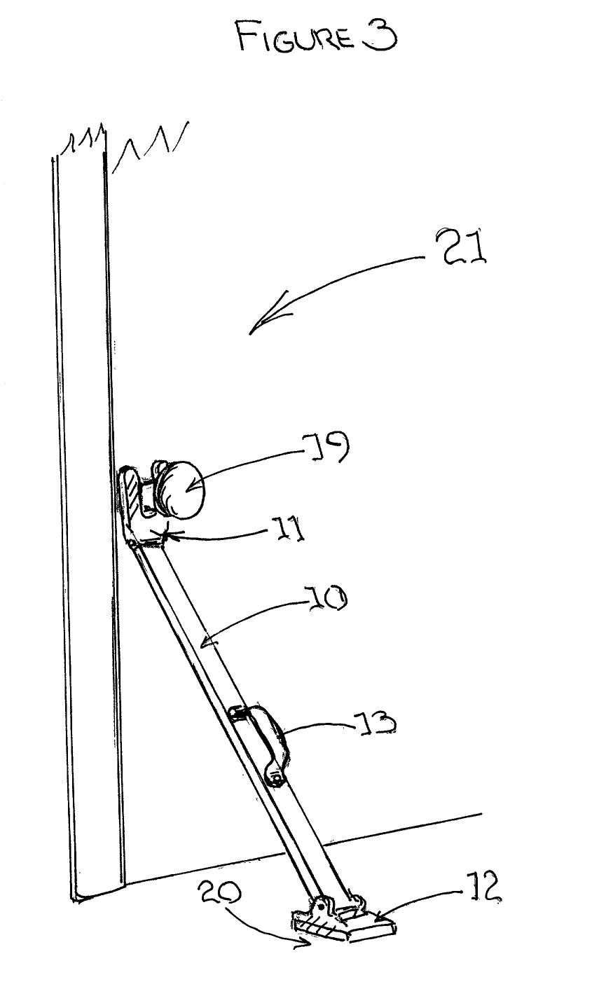

Operation—FIG. 3

The manner of using the security stop bar is illustrated in FIG. 3. The operator grasps the security stop bar by the bar handle (13) and places the knob fork (11) under the door knob (19). The floor foot (12) is placed against the floor surface (20) in such a fashion as to reduce the angle of the brace bar (10) relative to the door (21) by keeping the floor foot (12) in contact with the floor surface (20). Any attempt to open the door (21) will result in jamming the bar tighter against the floor surface (20), thus preventing the door (21) from being opened. The security stop bar may be easily removed by means of lifting the bar handle (13).

Conclusion, Ramifications, and Scope

Accordingly the examiner will see that the security stop bar of this invention can be easily be used by the elderly, the mobility, facility and visually impaired. Further, the security stop bar has the additional advantages in that

it is easy to operate since it does not require assembly, nor physical strength, or manual dexterity to use.

It doesn't require complicated setup or operating instructions;

it has a handle for easy placement, removal, and transport.

Although the description herein presented contains many specificities, these should not be construed as limiting the scope of the invention, but as merely providing illustrations of some of the preferred embodiments of this invention.

Thus the scope of this invention should be determined by the appended claims and their legal equivalents, rather than by the examples herein given and illustrated.

I claim:

1. In a security stop bar of type comprising a brace bar with a pivoting knob fork, a pivoting floor foot, and a bar handle.

2. The security stop bar of claim 1 wherein said brace bar, pivoting fork, and pivoting floor foot are constructed of aluminum.

3. The security stop bar of claim 1 wherein said brace bar is 40 inches in length, and of square cross-section of one inch outside diameter.

4. The security stop bar of claim 3 wherein said bar handle is affixed just below the midpoint of the front surface of said brace bar.

5. The security stop bar of claim 1 wherein said knob fork and said floor foot are affixed to opposite ends of said brace bar in the same axis.

6. The security stop bar of claim 5 wherein said knob fork, and said floor foot pivot by means of roll pins functioning as axles.

7. The security stop bar of claim 5 wherein said fork and said floor foot are coated in rubberized material.
